(19) United States
(12) Patent Application Publication
(10) Pub. No.: US 2023/0107169 A1
(43) Pub. Date: Apr. 6, 2023

(54) GOLF BALL

(71) Applicant: Bridgestone Sports Co. Ltd., Tokyo (JP)

(72) Inventor: Masahiro YAMABE, Chichibushi (JP)

(73) Assignee: Bridgestone Sports Co. Ltd., Tokyo (JP)

(21) Appl. No.: 17/958,846

(22) Filed: Oct. 3, 2022

(30) Foreign Application Priority Data
Oct. 4, 2021 (JP) 2021-163388
Dec. 16, 2021 (JP) 2021-204014

(51) Int. Cl. A63B 37/00; C08L 75/08

(52) U.S. Cl. CPC A63B 37/0024; A63B 37/0074; A63B 37/0031; C08L 75/08

(57) ABSTRACT

In a golf ball having a rubber core of at least one layer and a cover of at least one layer encasing the core, at least one layer of the cover is formed of a resin composition that includes (I) a polyurethane or a polyurea and (II) a (meth)acrylic block copolymer, the (meth)acrylic block copolymer serving as component (II) being included in an amount of 20 parts by weight or less per 100 parts by weight of component (I). The golf ball has an excellent controllability on approach shots and is able to maintain a good scuff resistance and moldability.

### CROSS-REFERENCE TO RELATED APPLICATION

This non-provisional application claims priority under 35 U.S.C. § 119(a) on Patent Application Nos. 2021-163388 and 2021-204014 filed in Japan on Oct. 4, 2021 and Dec. 16, 2021, respectively, the entire contents of which are hereby incorporated by reference.

### TECHNICAL FIELD

The present invention relates to a golf ball having a core of at least one layer and a cover of at least one layer.

### BACKGROUND ART

The property most desired in a golf ball is an increased distance, but other desirable properties include the ability for the ball to stop well on approach shots and a good scuff resistance. Many golf balls have hitherto been developed that exhibit a good flight performance on shots with a driver and are suitably receptive to backspin on approach shots. Recently, in golf balls for professional golfers and skilled amateurs, urethane resin materials are often used in place of ionomer resin materials as the cover material.

A number of cover materials that are polymer blends obtained by using a urethane resin as the base resin and mixing therein other resin materials have been described in the art. The inventor has earlier disclosed, in JP-A 2019-107401, the inclusion of an acrylic resin or methacrylic resin in a urethane resin material polymer blend and the use of this polymer blend as the base resin of a golf ball cover. Although this art does provide a golf ball which can achieve a higher initial velocity on driver shots and also can achieve a lower initial velocity on approach shots, because acrylic resins and methacrylic resins are basically hard resin materials, a sufficient degree of controllability on approach shots cannot be obtained. The controllability of the club on approach shots is a key factor in ball controllability on approach shots, and the quality of the club controllability is influenced by the degree of spin by the ball and also the length of contact (contact time) between the ball and the clubface arising from the low resilience. When the contact time is long, the controllability improves; when it is short, the controllability worsens. A golf ball of even better controllability on approach shots than the golf ball of JP-A 2019-107401 has thus been desired.

In the cover-forming resin material of JP-A 2019-107401, the melt viscosity of the urethane resin material rises with admixture of the acrylic resin, worsening the flowability and thus making it necessary to increase the molding temperature. As a result, after molding, defects such as scorching of the overall cover surface may arise. Hence, there remains room for improvement in the moldability and scuff resistance of the golf ball.

JP-A 2019-88770 does disclose a golf ball resin material formed of a mixture of a thermoplastic polymer and an acrylic copolymer (MMA copolymer). However, the acrylic copolymer in this prior art is a polymer having a special, core-shell type chemical structure and so, because JP-A 2019-88770 makes no mention of a sufficient improvement in the ball controllability on approach shots and excellent scuff resistance and moldability when this acrylic copolymer is blended with a urethane resin material, this prior art does not achieve the object of the present invention.

### SUMMARY OF THE INVENTION

It is therefore an object of the present invention to provide a golf ball which, compared with golf balls having a conventional urethane cover, has an excellent controllability on approach shots and is able to fully satisfy the scuff resistance and moldability.

As a result of intensive investigations, I have discovered that by having a polymer blend which is a resin material composed primarily of a polyurethane or polyurea and includes within a specific range a (meth)acrylic block copolymer serve as the cover material in a golf ball having a core and a cover, when a golf ball in which a molding of the resin composition made up of these ingredients serves as the cover is produced, the golf ball has an excellent controllability on approach shots and possesses both a good scuff resistance and a good moldability. That is, the golf ball of the invention, by employing a (meth)acrylic type block copolymer having a relatively low Shore D hardness and a relatively low rebound resilience as an added resin within a resin composition made up primarily of polyurethane or polyurea, is endowed with a sufficiently high controllability on approach shots. Also, even when the above (meth)acrylic block copolymer is mixed into a base resin of polyurethane or the like, the melt viscosity does not rise during molding, and so there is no problem whatsoever with the moldability (productivity), enabling golf balls to be obtained which are fully satisfactory in terms of scuff resistance and moldability.

Accordingly, the invention provides a golf ball having a rubber core of at least one layer and a cover of at least one layer encasing the core, wherein at least one layer of the cover is formed of a resin composition which includes:

(I) a polyurethane or a polyurea, and

(II) a (meth)acrylic block copolymer;

the (meth)acrylic block copolymer serving as component (II) being included in an amount of not more than 20 parts by weight per 100 parts by weight of component (I).

In a preferred embodiment of the golf ball of the invention, the block copolymer serving as component (II) includes two or more blocks constituting hard segments and one or more block constituting a soft segment.

In another preferred embodiment of the inventive golf ball, component (II) has a material hardness on the Shore D hardness scale of not more than 40.

In yet another preferred embodiment, component (II) has a rebound resilience, as measured according to JIS-K 6255, of not more than 50%.

In still another preferred embodiment, the hard segments in the block copolymer serving as component (II) are composed primarily of methyl methacrylate units.

In a further preferred embodiment, the soft segment in the block copolymer serving as component (H) is composed primarily of n-butyl acrylate units.

In a yet further preferred embodiment, component (II) has a weight-average molecular weight of 10,000 or more.

In a still further preferred embodiment, the resin composition further comprises (III) a thermoplastic polyester elastomer. In one version of this preferred embodiment, component (III) may have a material hardness on the Shore D hardness scale of from 20 to 50. In another version, component (III) may have a rebound resilience, as measured according to JIS-K 6255, of from 50 to 80%. In yet another version, Component (III) may have a melt viscosity at 200° C. and a shear rate of 243 s⁻¹ of from 0.3×10⁴ to 1.5×10⁴ dPa·s.

In another preferred embodiment of the inventive golf ball, the cover has a Shore D hardness of not more than 48.

In yet another preferred embodiment, letting HMa (N/mm²) be the Martens hardness of the resin material of component (I) and MTh (N/mm⁻²) be the Martens hardness of the cover layer formed of the resin composition containing components (I) and (II), HMa and HMb satisfy formula (1) below

1.020≤HMa/HMb≤1.500 (1).

In this preferred embodiment, letting ηItb (%) be the elastic work recovery of the cover layer formed of the resin composition containing components (1) and (II), ηItb and HMb may satisfy formula (2) below

5.00≤ηItb/HMb≤8.00 (2).

In the foregoing embodiment, letting ηIta (%) be the elastic work recovery of the resin material of component (I), ηIta and ηItb may satisfy formula (3) below

0.97≤ηIta/ηItb≤1.12 (3).

The golf ball may further satisfy formula (4) below

0.70≤(ηIta·HMb)/(ηItb·HMa)≤1.06 (4)

### Advantageous Effects of the Invention

The golf ball of the invention, compared with conventional golf ball having a urethane cover, has an even more outstanding controllability on approach shots, in addition to which it is able to maintain a good scuff resistance and also has a good moldability.

### DESCRIPTION OF THE PREFERRED EMBODIMENTS

The objects, features and advantages of the invention will become more apparent from the following detailed description.

As used in this Specification, “(meth)acrylic block copolymer” refers collectively to acrylic block copolymers and methacrylic block copolymers.

The golf ball of the invention has a core of at least one layer and a cover of at least one layer—that is, a single-layer or multilayer cover—that encases the core.

The core may be formed using a known rubber material as the base material. A known base rubber such as a natural rubber or a synthetic rubber may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the foregoing polybutadiene in the base rubber.

The polybutadiene may be synthesized with a metal catalyst, such as a neodymium or other rare-earth catalyst, a cobalt catalyst or a nickel catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core may be produced by vulcanizing/curing the rubber composition containing the above ingredients. For example, production may be carried out by kneading the composition using a mixer such as a Banbury mixer or a roll mill, compression molding or injection molding the kneaded composition using a mold, and curing the molded body by suitably heating it at a temperature sufficient for the organic peroxide and the co-crosslinking agent to act, i.e., from 100° C. to 200° C., and preferably from 140 to 180° C., for a period of 10 to 40 minutes.

In the golf ball of the invention, the core is encased by a cover of one or more layer. Such a golf ball may take the form of, for example, a golf ball having a single-layer cover over a core, or a golf ball having a core, an intermediate layer encasing the core, and an outermost layer encasing the intermediate layer.

In this invention, at least one layer of the cover is formed of a resin composition containing components (I) and (II) below:

(I) a polyurethane or a polyurea

(II) a (meth)acrylic block copolymer.

### (I) Polyurethane or Polyurea

The polyurethane or polyurea is a substance that is capable of serving as the base resin of the above cover material (resin composition). The polyurethane (I-a) or polyurea (I-b) used as this component is described in detail below.

### (I-a) Polyurethane

The polyurethane has a structure which includes soft segments composed of a polymeric polyol (polymeric glycol) that is a long-chain polyol and hard segments composed of a chain extender and a polyisocyanate. Here, the polymeric polyol serving as a starting to material may be any that has hitherto been used in the art relating to polyurethane materials, and is not particularly limited. It is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include polyethylene glycol), polypropylene glycol), poly(tetramethylene glycol) and poly(methyltetramethylene glycol). These polyols may be used singly, or two or more may be used in combination.

It is preferable to use a polyether polyol as the above polymeric polyol.

The long-chain polyol has a number-average molecular weight that is preferably in the range of 1,000 to 5,000. By using a long-chain polyol having a number-average molecular weight in this range, golf balls made with a polyurethane composition that have excellent properties, including a good rebound and good productivity, can be reliably obtained. The number-average molecular weight of the long-Chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic dials having from 2 to 12 carbon atoms. Specific examples include 1,4-butylene glycol, 1,2-ethylene 1,3-butanediol, 1,6-hexanediol and 2,2-dimethyl-1,3-propanediol. The use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbomene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method of preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane, with an ether-based thermoplastic polyurethane material being especially preferred. The thermoplastic polyurethane material used may be a commercial product, illustrative examples of which include those available under the registered trademark PANDEX from DIC Covestro Polymer, Ltd., and those available under the trade name RESAMINE from Dainichiseika Color &. Chemicals Mfg. Co., Ltd.

### (I-b) Polyurea

The polyurea is a resin composition composed primarily of urea linkages formed by reacting (i) an isocyanate with (ii) an amine-terminated compound. This resin composition is described in detail below.

### (i) Isocyanate

The isocyanate is not particularly limited. Any isocyanate used in the prior art relating to polyurethanes may be suitably used here. Use may be made of isocyanates similar to those mentioned above in connection with the polyurethane material.

### (ii) Amine-Terminated Compound

An amine-terminated compound is a compound having an amino group at the end of the molecular chain. In this invention, the long-chain polyamines and/or amine curing agents shown below may be used.

A long-chain polyamine is an amine compound which has on the molecule at least two amino groups capable of reacting with isocyanate groups, and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

An amine curing agent is an amine compound which has on the molecule at least two amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylatuinopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-totuenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the poly urea. The polyol is not particularly limited, but is preferably one that has hitherto been used in the art relating to polyurethanes. Specific examples include the long-chain polyols and/or polyol curing agents mentioned below,

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1,700 to 3,500. In this average molecular weight range, an even better rebound and productivity are obtained.

The polyol curing agent is preferably one that has hitherto been used in the art relating to polyurethanes, but is not subject to any particular limitation. In this invention, use may be made of a low-molecular-weight compound having on the molecule at least two active hydrogen atoms capable of reacting with isocyanate groups and having a molecular weight of less than 1,000. Of these, the use of aliphatic dials having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight of preferably less than 800, and more preferably less than 600.

A known method may be used to produce the poly urea. A prepolymer process, a one-shot process or some other known method may be suitably selected for this purpose.

Component (I) has a material hardness on the Shore D hardness scale which, from the standpoint of the spin properties and scuff resistance that can be obtained in the golf ball, is preferably 52 or less, more preferably 50 or less, and even more preferably 48 or less. From the standpoint of the moldability, the lower limit in the material hardness on the Shore D scale is preferably at least 38, and more preferably at least 40.

Component (I) has a rebound resilience which, from the standpoint of increasing the spin rate of the ball on approach shots, is preferably 5.5% or more, more preferably 57% or more, and even more preferably 59% or more. The rebound resilience is measured based on JIS-K 6255:2013.

Component (I) serves as the base resin of the resin composition. To fully confer the scuff resistance of the urethane resin, it accounts for at least 50 wt %, preferably at least 60 wt %, more preferably at least 70 wt %, even more preferably at least 80 wt %, and most preferably at least 90 wt %, of the resin composition.

In this invention, by blending component (II) described in detail below with above component (I), a golf ball of excellent controllability on approach shots, scuff resistance and moldability can be obtained.

### (II) (Meth)acrylic Block Copolymer

The (meth)acrylic block copolymer serving as component (II) is preferably a block copolymer having two or more blocks that constitute hard segments and one or more block that constitutes a soft segment. That is, the (meth)acrylic block copolymer used in this invention is a polymer which includes block polymers A and B and can be represented as an A-B or A-B-A chemical structure. The (meth)acrylic block copolymer used in this invention has a chemical structure which differs from that of ordinary core-shell type acrylic copolymers of the sort described in JP-A 2019-88770.

Block Polymer A is a region that constitutes a hard segment. Specific examples of the monomer units therein include methacrylic acid esters such as methyl methacrylate, ethyl methacrylate, isopropyl methacrylate, isobutyl methacrylate, sec-butyl methacrylate, tert-butyl methacrylate, cyclohexyl methacrylate, isobornyl methacrylate, phenyl methacrylate and 2-hydroxyethyl methacrylate. The use of primarily methyl methacrylate (MMA) is preferred. Block Polymer A may be composed entirely of one of these monomer units or may be composed of two or more used in combination.

Block Polymer B is a region that constitutes a soft segment. Specific examples of the monomer units therein include acrylic acid esters such as methyl acrylate, ethyl acrylate, n-propyl acrylate, isopropyl acrylate, n-butyl acrylate, isobutyl acrylate, sec-butyl acrylate, amyl acrylate, isoamyl acrylate, n-hexyl acrylate, 2-ethylhexyl acrylate, pentadecyl acrylate, dodecyl acrylate, benzyl acrylate, phenoxyethyl acrylate and 2-methoxyethyl acrylate. The use of primarily n-butyl acrylate (nBA) is preferred. Block Polymer B may be composed entirely of one of these monomer units or may be composed of two or more used in combination.

The Block Polymer A which constitutes the hard segments has a glass transition temperature (Tg) that is preferably between 80° C. and 140° C., and more preferably between 100° C., and 120° C. The Block Polymer B which constitutes the soft segments has a glass transition temperature (Tg) that is preferably between −80° C. and −20° C., and more preferably between −60° C. and −40° C.

In the above (meth)acrylic block copolymer, the content ratio between the hard segments and the soft segments, expressed as a weight ratio, is preferably between 5:95 and 40:60, and more preferably between 10:90 and 30:70. The higher the proportion of soft segments, the more likely that the resin composition can be softened and the desired controllability on approach shots obtained. However, if the proportion of hard segments is too low, the compatibility with the polyurethane resin and the like serving as the base resin may decrease, worsening the moldability.

The (meth)acrylic block copolymer can be obtained by polymerizing the various above monomer units. The method of polymerization is exemplified by radical polymerization, living anionic polymerization and living radical polymerization. Examples of the mode of polymerization include solution polymerization, emulsion polymerization suspension polymerization and bulk polymerization.

The (meth)acrylic block copolymer has a weight-average molecular weight which is not particularly limited but, from the standpoint of moldability and plasticity, is preferably in the range of 20,000 to 700,000, and more preferably in the range of 50,000 and 200,000. The weight-average molecular weight can be measured by gel permeation chromatography (GPC).

The meth(acrylic) block copolymer used in this invention is preferably a polymer in which the hard segments are composed primarily of methyl methacrylate units and the soft segment is composed primarily of n-butyl acrylate units. Commercial products such as those available from Kuraray Co., Ltd. under the trademark “Kurarity” may be used as such a (meth)acrylic block copolymer. Specific examples include Kurarity LA2250 and Kurarity LA 2270.

Component (II) has a material hardness on the Shore D hardness scale which, from the standpoint of increasing the spin rate of the ball on approach shots, is preferably not more than 38, more preferably not more than 35, and even more preferably not more than 32. The lower limit of the Shore D hardness is preferably 5 or more, more preferably 10 or more, and even more preferably 20 or more.

Component (II) has a rebound resilience which, from the standpoint of both maintaining a good spin rate and holding down the rebound on approach shots and thus obtaining a good controllability, is preferably not more than 40%, more preferably not more than 35%, and even more preferably not more than 30%. The lower limit value of this rebound resilience is preferably 10% or more, more preferably 15% or more, and even more preferably 20% or more. The rebound resilience is measured based on JIS-K 6255:2013.

The content of component (11) per 100 parts by weight of component (1) is not more than 20 parts by weight, preferably not more than 15 parts by weight, and more preferably not more than 12 parts by weight. At a value in excess of this, the scuff resistance may decrease. This content has a lower limit of 0.5 part by weight or more, preferably 1 part by weight or more, and more preferably 2 parts by weight or more, per 100 parts by weight of component (1).

The resin composition containing above components (I) and (II) may additionally include (III) a thermoplastic polyester elastomer. This thermoplastic polyester elastomer is described below.

### (III) Thermoplastic Polyester Elastomer

In order to achieve the desired effects of the invention and also further improve the feel of the ball at impact, a specific thermoplastic polyester elastomer may be included in the resin composition. This specific thermoplastic polyester elastomer is a component which imparts at least a given level of resilience to the resin composition and along with imparting such resilience, enables the spin rate of the ball on approach shots to be maintained at or above a given level. By including the specific thermoplastic polyester elastomer in the resin composition, the compatibility with component (I) serving as the base resin is good, as a result of which the golf ball can be conferred with a good scuff resistance. In addition, including the specific thermoplastic polyester elastomer in the resin composition provides at least a given level of melt viscosity, imparting the resin composition with hardenability after it has been molded. That is, the thermoplastic polyester elastomer suppresses a decline in the viscosity of the overall resin composition due to the softness of component (I) serving as the base resin, thus preventing a decrease in moldability (productivity) and an increase in appearance defects in the molded golf ball and also holding down a rise in production costs owing to an increased cooling time. Such a thermoplastic polyester elastomer is described below.

The thermoplastic polyester elastomer serving as component (III) is a resin composition made up of (III-a) a polyester block copolymer and (III-b) a rigid resin. Component (III-a) is made up of, in turn, (III-a1) a high-melting crystalline polymer segment and (III-a2) a low-melting polymer segment.

The high-melting crystalline polymer segment (III-a1) within the polyester block copolymer serving as component (III-a) is a polyester made of one or more compound selected from the group consisting of aromatic dicarboxylic acids and ester-firming derivatives thereof and dials and ester-forming derivatives thereof.

Specific examples of the aromatic dicarboxylic acids include terephthalic acid, isophthalic acid, phthalic acid, 2,6-naphthalenedicarboxylic acid, 2,7-naphthalenedicarboxylic acid, anthracenedicarboxylic acid, diphenyl-4,4′-dicarboxylic acid, diphenoxyethanedicarboxylic acid, 4,4′-diphenyletherdicarboxylic acid, 5-sulfoisophthalic acid and sodium 3-sulfoisophthalate. In this invention, an aromatic dicarboxylic acid is primarily used. However, where necessary, a portion of this aromatic dicarboxylic acid may be substituted with an alicyclic dicarboxylic acid such as 1,4-cyclohexanedicarboxylic acid, cyclopentanedicarboxylic acid or 4,4′-dicyclohexyldicarboxylic acid or with an aliphatic dicarboxylic acid such as adipic acid, succinic acid, oxalic acid, sebacic acid, dodecanedioic acid or dimer acid. Exemplary ester-forming derivatives of dicarboxylic acids include lower alkyl esters, aryl esters, carboxylic acid esters and acid halides of the above dicarboxylic acids.

Next, a diol having a molecular weight of not more than 400 may be suitably used as the diol. Specific examples include aliphatic diols such as 1,4-butanediol, ethylene glycol, trimethylene glycol, pentamethylene glycol, hexamethylene glycol, neopentyl glycol and decamethylene glycol; alicyclic diols such as 1,1-cyclohexanedimethanol, 1,4-dicyclohexanedimethanol and tricyclodecanedimethanol; and aromatic diols such as xylylene glycol, bis(p-hydroxy)diphenyl, bis(p-hydroxy)diphenylpropane, 2,2′-bis[4-(2-hydroxyethoxy)phenyl]propane, bis[4-(2-hydroxyethoxy)phenyl]sulfone, 1,1-bis[4-(2-hydroxyethoxy)pentyl]cyclohexane, 4,4′-dihydroxy-p-terphenyl and 4,4′-dihydroxy-p-quaterphenyl. Exemplary ester-forming derivatives of diols include acetylated forms and alkali metal salts of the above diols.

These aromatic dicarboxylic acids, diols and derivatives thereof may be used singly or two or more may be used together.

In particular, the following may be suitably used as component (III-a1): high-melting crystalline polymer segments composed of polybutylene terephthalate units derived from terephthalic acid and/or dimethyl terephthalate together with 1,4-butanediol, high-melting crystalline polymer segments composed of polybutylene terephthalate units derived from isophthalic acid and/or dimethyl isophthalate together with 1,4-butanediol; and copolymers of both.

The low-melting polymer segment serving as component (III-a2) is an aliphatic polyether and/or an aliphatic polyester.

Examples of aliphatic polyethers include polyethylene oxide) glycol, polypropylene oxide) glycol, poly(tetramethylene oxide) glycol, poly(hexamethylene oxide) glycol, copolymers of ethylene oxide and propylene oxide, ethylene oxide addition polymers of polypropylene oxide) glycol, and copolymer glycols of ethylene oxide and tetrahydrofuran. Examples of aliphatic polyesters include poly(E-caprolactone), polyenantholactone, polycaprolactone, polybutylene adipate and polyethylene adipate. In this invention, from the standpoint of the elastic properties, suitable use can be made of poly(tetramethylene oxide) glycol, ethylene oxide adducts of poly(propylene oxide) glycol, copolymer glycols of ethylene oxide and tetrahydrofuran, polys-caprolactone), polybutylene adipate and polyethylene adipate. Of these, the use of, in particular, poly(tetramethylene oxide) glycol, ethylene oxide adducts of polypropylene oxide) glycol and copolymer glycols of ethylene oxide and tetrahydrofuran is recommended. The number-average molecular weight of these segments in the copolymerized state is preferably from about 300 to about 6,000.

Component (III-a) can be produced by a known method. Specifically, use can be made of, for example, the method of carrying out a transesterification reaction on a lower alcohol diester of a dicarboxylic acid, an excess amount of a low-molecular-weight glycol and a low-melting polymer segment component in the presence of a catalyst and polycondensing the resulting reaction product, or the method of carrying out an esterification reaction on a dicarboxylic acid, an excess amount of glycol and a low-melting polymer segment component in the presence of a catalyst and polycondensing the resulting reaction product.

The proportion of component (III-a) accounted for by component (III-a2) is from 30 to 60 wt %. The preferred lower limit in this case can be set to 35 wt % or more, and the preferred upper limit can be set to 55 wt % or less. When the proportion of component (III-a2) is too low, the impact resistance (especially at low temperatures) and the compatibility may be inadequate. On the other hand, when the proportion of component (III-a2) is too high, the rigidity of the resin composition (and the molded body) may be inadequate.

The rigid resin serving as component (III-b) is not particularly limited. For example, one or more selected from the group consisting of polycarbonates, acrylic resins, styrene resins such as ABS resins and polystyrenes, polyester resins, polyamide resins, polyvinyl chlorides and modified polyphenylene ethers may be used, in this invention, from the standpoint of compatibility, a polyester resin may be preferably used. More preferably, the use of polybutylene terephthalate and/or polybutylene naphthalate is recommended.

Component (III-a) and component (III-b) are blended in a weight ratio, expressed as (III-a):(III-b), which is not particularly limited, although this ratio is preferably set to from 50:50 to 90:10, and more preferably from 55:45 to 80:20. When the proportion of component (III-a) is too low, the low-temperature impact resistance may be inadequate. On the other hand, when the proportion of (III-a) is too high, the rigidity of the composition (and the molded body), as well as the molding processability, may be inadequate.

A commercial product may be used as this thermoplastic polyester elastomer (III). Specific examples include those available as Hytrel® from DuPont-Toray Co. Ltd.

Component (III) has a material hardness on the Shore D hardness scale which, from the standpoint of enhancing the spin rate on approach shots, is preferably not more than 50, and more preferably not more than 43. The lower limit is a Shore D hardness of preferably at least 20, and more preferably at least 30.

Component (III) has a rebound resilience which, to lower the initial velocity on approach shots, is preferably 50% or more, and more preferably 60% or more. The upper limit is preferably not more than 80%, and more preferably not more than 70%. The rebound resilience is measured in accordance with JIS-K 6255: 2013.

Component (III) has a melt viscosity of preferably at least 0.3×10⁴ dPa·s, and more preferably at least 0.4×10⁴ dPa·s. The upper limit value is preferably not more than 1.5×10⁴ dPa·s, and more preferably not more than 1.0×10⁴ dPa·s. With this melt viscosity, hardenability after molding of the resin composition is imparted and a decrease in moldability (productivity) can be prevented. This melt viscosity is a value measured with a Capilograph at a temperature of 200° C. and a shear rate of 243 sec⁻¹ in accordance with ISO 11443:1995.

Component (III) is included in a proportion per 100 parts by weight of the resin composition which is not more than 30 parts by weight, preferably not more than 20 parts by weight, and more preferably not more than 15 parts by weight. The lower limit value is preferably 3 parts by weight or more, more preferably 5 parts by weight or more, and even more preferably 10 parts by weight or more. In excess of this value, the moldability and scuff resistance may decrease.

Other resin materials may also be included in the resin composition containing above components (I), (II) and (III). The purposes for doing so are, for example, to further improve the flowability of the golf ball resin composition and to enhance such ball properties as the rebound and the durability to cracking.

Specific examples of other resin materials that may be used include polyamide elastomers, ionomer resins, ethylene-ethylene/butylene-ethylene block copolymers and modified forms thereof, polyacetals, polyethylenes, nylon resins, styrene resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the above resin composition. This active isocyanate compound reacts with the polyurethane or polyurea serving as the base resin, enabling the scuff resistance of the overall resin composition to be further enhanced. Moreover, the isocyanate has a plasticizing effect which increases the flowability of the resin composition, enabling the moldability to be improved.

Any isocyanate compound employed in ordinary polyurethanes may be used without particular limitation as the above isocyanate compound. For example, aromatic isocyanate compounds that may be used include 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by isocyanate dimerization.

The amount of the above isocyanate compounds included per 100 parts by weight of the polyurethane or polyurea serving as component (I) is preferably at least 0.1 part by weight, and more preferably at least 0.5 part by weight. The upper limit is preferably not more than 30 parts by weight, and more preferably not more than 20 parts by weight. When too little is included, sufficient crosslinking reactions may not be obtained and an improvement in the properties may not be observable. On the other hand, when too much is included, discoloration over time due to heat and ultraviolet light may increase, or problems such as a loss of thermoplasticity or a decline in resilience may arise.

In addition, depending on the intended use, optional additives may be suitably added to the above resin composition. For example, in cases where the golf ball material of the invention is to be used as the cover material, various additives such as fillers (inorganic fillers), organic staple fibers, reinforcing agents, crosslinking agents, pigments, dispersants, antioxidants, ultraviolet absorbers and light stabilizers may be suitably added to the above ingredients. When including such additives, the amount thereof per 100 parts by weight of the base resin is preferably at least 0.1 part by weight, and more preferably at least 0.5 part by weight; the upper limit is preferably not more than 10 parts by weight, and more preferably not more than 4 parts by weight.

In order to achieve a low rebound and increase the spin rate of the ball on approach shots, the above resin composition has a rebound resilience, as measured according to JIS-K 6255:2013, which is preferably at least 48%, more preferably at least 50%, and even more preferably at least 52%. The upper limit is preferably not more than 72%, more preferably not more than 70%, and even more preferably not more than 68%.

The resin composition has a material hardness on the Shore D hardness scale which, from the standpoint of the scuff resistance and imparting a suitable spin rate on approach shots, is preferably not more than 50, more preferably not more than 48, and even more preferably not more than 45. From the standpoint of moldability, the lower limit in the material hardness on the Shore D hardness scale is preferably at least 30, more preferably at least 35, and even more preferably at least 37.

The above resin composition may be prepared by mixing together the ingredients using any of various types of mixers, such as a kneading-type single-screw or twin-screw extruder, a Banbury mixer, a kneader or a Labe Plastomill. Alternatively, the ingredients may be mixed together by dry blending when the resin composition is to be injection-molded. In addition, when an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is to be injection molded.

The method of molding the cover from the above resin composition may involve, for example, feeding the resin composition into an injection molding machine and molding the cover by injecting the molten resin composition over the core. In this case, the molding temperature differs according to the type of polyurethane or polyurea (I) serving as the chief ingredient, but is typically in the range of 150 to 270° C.

In this invention, letting HMa (N/mm²) be the Martens hardness of the resin material serving as component (I) and HMb (N/mm²) be the Martens hardness of the cover layer formed of the resin composition containing components (I) and (II), to obtain a good controllability on approach shots while maintaining the scuff resistance, it is desirable for the ball to satisfy formula (1) below.

1.020≤HMa/HMb≤1,500 (1)

The lower limit of formula (1) is preferably at least 1.020, more preferably at least 1.050, and even more preferably at least 1.100. The upper limit is preferably not more than 1.500, more preferably not more than 1,400, and even more preferably not more than 1.300. When the formula (1) value is too large, the scuff resistance may decrease. When it is too small, the controllability of the ball on approach shots may decrease.

The Martens hardness HMa of the resin material serving as component (1) has a lower limit of preferably at least 10.00 N/mm², and more preferably at least 11.00 N/mm². The upper limit is preferably not more than 30.00 N/mm², and more preferably not more than 25.00 N/mm².

The Martens hardness 11 Mb of the cover layer formed of the resin composition containing components (I) and (II) has a lower limit of preferably at least 8.00 N/mm², and more preferably at least 9.00 N/mm². The upper limit is preferably not more than 28.00 N/mm², and more preferably not more than 23.00 N/mm².

The Martens hardnesses HMa. and HMb can be measured with a nanohardness tester based on ISO 14577: 2002 (“Metallic materials—Instrumented indentation test for hardness and materials parameters”). This is a physical value determined by pressing an indenter into the object being measured while applying a load to the indenter, and is calculated as (indentation force [N])/(surface area of region to which pressure is applied [mm²]). Measurement of the Martens hardness may be carried out using, for example, the nanohardness tester available from Fischer Instruments under the product name Fischerscope HM2000. This instrument can, for example, measure the hardness of the cover while continuously increasing the load in a stepwise manner. The nanohardness test conditions may be set to room temperature, 10 seconds and an applied load of 50 mN.

When measuring the surface of the cover, in cases where a coat or the like has been formed on the cover surface, specifying the surface hardness is difficult. Also, deep positions from the cover surface toward the center of the ball are affected by the hardness of the adjacent layer. Hence, given that the Martens hardness inherent to the cover can be stably obtained at a position about 0.3 mm from the cover surface toward the center of the ball, it is desirable to measure the Martens hardness at this position.

Also, letting ηItb (%) be the elastic work recovery of the cover layer that is formed of the resin composition containing above components (I) and (II), it is preferable for the ball to satisfy formula (2) below.

5.00≤ηItb/HMb≤8.00 (2)

The formula (2) value has a lower limit of preferably at least 5.00, more preferably at least 5.30, and even more preferably at least 5.80. The upper limit is preferably not more than 8.00, more preferably not more than 7.50, and even more preferably not more than 7.20. At a formula (2) value that is too large or too small, the scuff resistance may worsen.

The elastic work recovers ηItb of the cover layer has a lower limit of preferably at least 50%, and more preferably at least 55%. The upper limit is preferably not more than 85%, and more preferably not more than 80%.

In addition, letting the elastic work recovery of the resin material serving as component (I) be ηIta [%], the golf hall preferably satisfies formula (3) below.

0.97≤ηIta/ηItb≤1.12 (3)

The lower limit value of formula (2) is preferably 0.97 or more, more preferably 0.98 or more, and even more preferably 0.99 or more. The lower limit value is preferably not more than 1.12, more preferably not more than 1.05, and even more preferably not more than 1.03. If the formula (3) value is too large, the scuff resistance or durability may worsen. On the other hand, if the formula (3) value is too small, the controllability of the golf ball on approach shots may worsen.

The elastic work recovery ηIta of the resin material serving as component (I) has a lower limit of preferably at least 45%, and more preferably at least 50%. The upper limit is preferably not more than 80%, and more preferably not more than 75%.

At elastic work recoveries ηIta and ηItb in these ranges, the cover formed at the golf ball surface has a high self-repairing/recovering ability while maintaining a constant hardness and elasticity, and is able to contribute to the excellent durability and scuff resistance of the ball. Moreover, even when the Martens hardness is low, in cases where the elastic work recoveries are too low, the ball has a good spin performance on approach shots but a poor scuff resistance. The method of measuring the elastic work recoveries is described below.

The elastic work recovery serves as one parameter of the nanoindentation method for evaluating the physical properties of the cover, this being a nanohardness test method that controls the indentation load on a micro newton (μN) order and tracks the indenter depth during indentation to a nanometer (nm) precision. In prior methods, only the size of the deformation (plastic deformation) mark corresponding to the maximum load could be measured. However, in the nanoindentation method, the relationship between the indentation load and the indentation depth can be obtained by continuous automated measurement. Hence, unlike in the past, there are no individual differences between observers when visually measuring a deformation mark under an optical microscope, and so it is thought that the physical properties of the cover can be precisely evaluated. Given that the golf ball cover is strongly affected by the impact of the driver and various other types of clubs and has a not inconsiderable influence on the golf ball properties, measuring the cover by the nanohardness test method and carrying out such measurement to a higher precision than in the past is a very effective method of evaluation.

In addition, from the standpoint of increasing the desired effects of the invention, the golf ball preferably satisfies formula (4) below.

0.70≤(ηIta·HMb)/(ηItb·HMa)≤106 (4)

The lower limit of the value in formula (4) is preferably 0.70 or more, more preferably 0.75 or more, and even more preferably 0.78 or more. The upper limit is preferably not more than 1.06, more preferably not more than 1.00, and even more preferably not more than 090. If the formula (4) value is too large, the spin rate of the golf ball on approach shots may worsen. On the other hand, if the formula (4) value is too small, the scuff resistance or durability of the ball may worsen.

The cover has a thickness which is preferably 0.4 mm or more, more preferably 0.5 mm or more, and even more preferably 0.6 mm or more. The upper limit is preferably not more than 3.0 mm, and more preferably not more than 2.0 mm.

In cases where at least one intermediate layer is interposed between the above core and the above cover, various types of thermoplastic resins used in golf ball cover materials, especially ionomer resins, may be used as the intermediate layer material. A commercial product may be used as the ionomer resin. In such a case, the thickness of the intermediate layer may be set within the same range as the above cover thickness.

In the golf ball of the invention, numerous dimples are provided on the surface of the outermost layer for reasons having to do with the aerodynamic performance. The number of dimples formed on the surface of the outermost layer is not particularly limited. However, to enhance the aerodynamic performance and increase the distance traveled by the ball, this number is preferably at least 250, more preferably at least 270, even more preferably at least 290, and most preferably at least 300. The upper limit is preferably not more than 400, more preferably not more than 380, and even more preferably not more than 360.

In this invention, a coating layer is formed on the cover surface. A two-part curable urethane coating may be suitably used as the coating that forms this coating layer. Specifically, in this case, the two-part curable urethane coating is one that includes a base resin composed primarily of a polyol resin and a curing agent composed primarily of a polyisocyanate.

A known method may be used without particular limitation as the method for applying this coating onto the cover surface and forming a coating layer. Use can be made of a desired method such as air gun painting or electrostatic painting.

The thickness of the coating layer, although not particularly limited, is typically from 8 to 22 tin, and preferably from 10 to 20 μm.

The golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof.

### Examples 1 to 16, Comparative Examples 1 to 6

### Formation of Core

A core-forming rubber composition formulated as shown in Table 1 and common to all of the Examples was prepared and then molded/vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiophenol | 0.3 |
| Zinc stearate | 1.0 |

Details on the above core material are given below.
cis-1,4-Polybutadiene: Available under the trade name BR01 from JSR Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

### Formation of Intermediate Layer

An intermediate layer-forming resin material was injection-molded over the 38.6 mm diameter core, thereby producing an intermediate layer-encased sphere having a 1.25 mm thick intermediate layer. This intermediate layer-forming resin material, which was a resin blend common to all of the Examples, consisted of 50 parts by weight of the sodium neutralization product of an ethylene-unsaturated carboxylic acid copolymer having an acid content of 18 wt % and 50 parts by weight of the zinc neutralization product of an ethylene-unsaturated carboxylic acid copolymer having an acid content of 15 wt %, for a total of 100 parts by weight.

### Formation of Cover (Outermost Layer)

Next, in Examples 2, 4, 6, 8, 10 to 12 and 14 to 16 and also in Comparative Example 2, the respective outermost layer-forming cover materials shown in Tables 2 and 3 were injection-molded over the intermediate layer-encased sphere, thereby producing a 42.7 mm-diameter three-piece golf ball having a 0.8 mm thick outermost layer. Dimples common to all of the Examples were formed at this time on the cover surface in each Example and Comparative Example. The resin compositions for the cover were designed so as to include the respective ingredients in the amounts shown in Tables 2 and 3 below, and were injection molded at a molding temperature of between 200 and 250° C.

In Examples 1, 3, 5, 7, 9 and 13 and also in Comparative Examples 1 and 3 to 6, the resin compositions for the cover are designed so as to include the respective ingredients in the amounts shown in Tables 2 and 3. Three-piece golf balls are produced in the same way as described above.

Details on the ingredients included in the compositions in Table 2 and 3 are given below.

### TPU (1):

An ether-type: thermoplastic polyurethane available from DIC Covestro Polymer, Ltd,

as Pandex® (Shore D hardness, 43)

### (Meth)acrylic Block Copolymer 1:

An acrylic block copolymer (hard segments, PMMA; soft segments, PBA)

available from Kuraray Co., Ltd. as Kurarity™ LA2250; Shore D hardness, 22 eth)acrylic Block Copolymer 2:

An acrylic block copolymer (hard segments, PMMA; soft segments, PBA)

available from Kuraray Co., Ltd. as Kurarity™ LA2270; Shore D hardness, 31 (Meth)acrylic Block Copolymer 3:

An acrylic block copolymer (hard segments, PMMA; soft segments, PBA)

available from Kuraray Co., Ltd. as Kurarity™ LA2140; Shore D hardness, 7 (Meth)acrylic Block Copolymer 4:

An acrylic block copolymer (hard segments, PMMA; soft segments, PBA)

available from Kuraray Co., Ltd. as Kurarity™ LA2330 Shore D hardness, 6

### PMMA 1:

A methacrylic resin available from Kuraray Co., Ltd. as Parapet™ Soft Acryl

SA-NW201 (Shore D hardness, 40)

### PMMA 2:

A methacrylic resin available from Kuraray Co., Ltd. as Parapet™ GF (Shore D hardness, 87)

### Hydrogenated Styrene Elastomer (1):

Available from Asahi Kasei Corporation as Tuftec™ H1051 (Shore D hardness, 45)

### Hydrogenated Styrene Elastomer (2):

Available from Asahi Kasei Corporation as Tuftec™ H1517 (Shore D hardness, 47)

### Thermoplastic Polyester Elastomer:

A thermoplastic polyether ester elastomer available from DuPont-Toray Co., Ltd. as Hytrel® 2401 (Shore D hardness, 40)

### Properties of Cover Resin Composition

### (1) Shore D Hardness

The resin material is formed into 2 mm thick sheets and left to stand for 2 weeks at a temperature of 23±2° C. At the time of measurement, three sheets are stacked together. The material hardness of the resin is measured using a Shore D durometer in accordance with ASTM D2240. The P2 Automatic Rubberi Hardness Tester (Kobunshi Keiki Co., Ltd.) equipped with a Shore D durometer is used for measuring the hardness.

### (2) Rebound Resilience

The rebound resiliences of the resin compositions measured based on JIS-K 6255:2013 are shown in Tables 2 and 3.

### (3) Melt Viscosity

The melt viscosities measured with a Capilograph at a temperature of 200° C. and a shear rate of 243 s⁻¹ in accordance with ISO 11443:1995 are shown in Tables 2 and 3.

The Martens hardness (HMa) and elastic work recovery (ηIta) of the polyurethane resin TPU1 used in the respective Examples and Comparative Examples are each measured by the methods described below. In addition, the Martens hardnesses (HMb) and elastic work recoveries (ηItb) of the cover layer (outermost layer)-forming resin compositions used in the respective Examples and Comparative Examples are each measured. The following four relationships among these parameters are then calculated:

HMa/HMb, Formula (1):

ηItb/HMb, Formula (2):

ηIta/ηItb, and Formula (3):

(ηIta·HMb)/(ηItb·HMa). Formula (4):

These calculated values are shown in Tables 2 and 3.

### Martens Hardness (HMb) of Outermost Layer (Cover Layer)

The golf ball in each Example is cut in half and, specifying a position on the ball cross-section that is located 0.3 mm from the surface of the cover toward the ball center, the Martens hardness HMa. (N/mm²) at this place is measured using the nanohardness tester available from Fischer Instruments under the product name Fischerscope HM2000. The nanohardness measurement conditions are room temperature and an applied load of 50 mN/10 s.

### Martens Hardness (HMa) of Resin Material

The Martens hardness (HMO obtained for the polyurethane resin TPU1 is shown below. The apparatus and conditions used for measuring the Martens hardness of this resin are the same as those mentioned above.

Martens hardness (HMa) of TPU 1: 14.3 N/mm²

### Elastic Work Recovery of Cover Layer (Outermost Layer)

The elastic work recovery of the cover layer is measured using the nanohardness tester available from Fischer Instruments under the product name Fischerscope HM2000. The measurement conditions are room temperature and an applied load of 50 mN/10 s. The elastic work recovery is calculated as follows, based on the indentation work Wₑₗₐₛₜ (Nm) due to spring-back deformation of the cover and on the mechanical indentation work Wₜₒₜₐₗ (Nm).

Elastic work recovery=Wₑₗₐₛₜ/Wₜₒₜₐₗ×100(%)

### Elastic Work Recovery of Resin Material

The elastic work recovery (%) of the polyurethane resin TPU1 is shown below. The apparatus and conditions used for measuring the elastic work recovery of this resin are the same as those mentioned above.

Elastic work recovery of TPU 1: 72%

The spin performance on approach shots, initial velocity performance, controllability on approach shots, scuff resistance and moldability of each golf ball are evaluated by the following methods. The results are shown in Tables 2 and 3.

### Initial Velocity and Spin Performance on Approach Shots

A sand wedge (SW) is mounted onto a golf swing robot, and the initial velocity and backspin rate of the ball immediately after being struck at a head speed (HS) of 20 m/s are measured with a launch monitor.

### Controllability on Approach Shots

Sensory evaluations of the controllability of the ball on approach shots are carried out by the following method. The club used is a sand wedge (SW) similar to that mentioned above: the TourStage TW-03 (loft angle, 57°) manufactured by Bridgestone Sports Co., Ltd. The controllability is judged based the following criteria when actually hit by golfers.
Excellent (Exc): Outstanding controllability
Good: Good controllability
Fair: Somewhat poor controllability
NG: Poor controllability,

In addition to the spin rate of the ball, the length of the contact time between the ball and the clubface arising from the low resilience also affects the judgment as to whether the controllability is good. When the contact time is long, the controllability is good; when it is short, the controllability worsens. What is being determined here is the controllability, which includes as factors the spin rate and the length of the contact time.

### Evaluation of Scuff Resistance

The golf balls are held isothermally at 23° C. and five balls of each type are hit at a head speed of 33 m/s using as the club a pitching wedge (PW) mounted on a golf swing robot. The damage to the ball from the impact is visually rated according to the following criteria.
Good: Slight scuffing or substantially no apparent scuffing.
NG: Dimples are completely obliterated.

### Evaluation of Moldability (Mold Releasability)

In each Example, the releasability of the ball from the mold following injection molding of the cover is rated according to the following criteria.
Exc: External defects such as runner stubs and ejector pin marks do not arise during demolding.
Good: External defects such as runner stubs and ejector pin marks arise during demolding, but molding proceeds without difficulty.
NG: External defects such as runner stubs and ejector pin marks arise during demolding or the molding temperature must be increased due to a rise in viscosity,

TABLE 2

| | | | Example | | | | | | | | | | |
|---|---|---|---|---|---|---|---|---|---|---|---|---|---|
| | | | 1 | 2 | 3 | 4 | 5 | 6 | 7 | 8 | 9 | 10 | 11 |
| Cover resin composition (pbw) | Component | TPU1 | 100 | 100 | 100 | 100 | 100 | 100 | 100 | 100 | 100 | 100 | 100 |
| | (I) | | | | | | | | | | | | |
| | Component | (Meth)acrylic | 3 | 5 | 10 | 15 | | | | | | | |
| | (II) | block copolymer (1) | | | | | | | | | | | |
| | | (Meth)acrylic | | | | | 3 | 5 | 10 | 15 | | | |
| | | block copolymer (2) | | | | | | | | | | | |
| | | (Meth)acrylic | | | | | | | | | 3 | 5 | 5 |
| | | block copolymer (3) | | | | | | | | | | | |
| | | (Meth)acrylic | | | | | | | | | | | |
| | | block copolymer (4) | | | | | | | | | | | |
| | Component | PMMA1 | | | | | | | | | | | |
| | (II′) | PMMA2 | | | | | | | | | | | |
| | | Hydrogenated styrene | | | | | | | | | | | |
| | | elastomer (1) | | | | | | | | | | | |
| | | Hydrogenated styrene | | | | | | | | | | | |
| | | elastomer (2) | | | | | | | | | | | |
| | Component | Thermoplastic polyester | | | | | | | | | | | 14.5 |
| | (III) | elastomer | | | | | | | | | | | |
| Properties of resin composition | Component | Elastic work | 72.0 | 72.0 | 72.0 | 72.0 | 72.0 | 72.0 | 72.0 | 72.0 | 72.0 | 72.0 | 72.0 |
| | (I) | recovery: ηIta | | | | | | | | | | | |
| | | Martens hardness: HMa | 14.3 | 14.3 | 14.3 | 14.3 | 14.3 | 14.3 | 14.3 | 14.3 | 14.3 | 14.3 | 14.3 |
| | | Shore D hardness | 43.0 | 43.0 | 43.0 | 43.0 | 43.0 | 43.0 | 43.0 | 43.0 | 43.0 | 43.0 | 43.0 |
| | Component | Shore D hardness | 22 | 22 | 22 | 22 | 31 | 31 | 31 | 31 | 7 | 7 | 7 |
| | (II) | Rebound resilience (%) | 28 | 28 | 28 | 28 | 26 | 26 | 26 | 26 | 30 | 30 | 30 |
| | | Weight-av erage | 50,000 | 50,000 | 50,000 | 50,000 | 45,000 | 45,000 | 45,000 | 45,000 | 60,000 | 60,000 | 60,000 |
| | | molecular weight | | | | | | | | | | | |
| | Component | Shore D hardness | | | | | | | | | | | 40 |
| | (III) | Rebound resilience (%) | | | | | | | | | | | 67 |
| | | Melt viscosity (10⁴ × dPa · s) | | | | | | | | | | | 0.57 |
| | Cover | Elastic work | 71.6 | 71.3 | 70.1 | 68.8 | 71.1 | 70.5 | 6.7 | 64.8 | 71.9 | 71.6 | 72.5 |
| | | recovery: ηItb | | | | | | | | | | | |
| | | Martens hardness: HMb | 13.9 | 13.6 | 12.8 | 12.0 | 13.9 | 13.6 | 13.6 | 13.6 | 13.0 | 12.6 | 13.0 |
| | | Shore D hardness | 42.4 | 42.0 | 41.1 | 40.2 | 42.7 | 42.4 | 41.9 | 41.5 | 42.0 | 41.3 | 41.1 |
| Formulas | Formula (1) | HMa/HMb | 1.030 | 1.048 | 1.117 | 1.189 | 1.030 | 1.051 | 1.051 | 1.055 | 1.099 | 1.131 | 1.100 |
| | Formula (2) | ηItb/HMb | 5.157 | 5.582 | 5.473 | 6.120 | 5.122 | 5.538 | 4.974 | 5.109 | 6.053 | 6.228 | 6.125 |
| | Formula (3) | ηIta/ηItb | 1.006 | 1.010 | 1.028 | 1.046 | 1.013 | 1.021 | 1.064 | 1.111 | 1.001 | 1.006 | 0.993 |
| | Formula (4) | (ηIta · HMb)/(ηItb · HMa) | 0.976 | 0.964 | 0.920 | 0.879 | 0.983 | 0.972 | 1.012 | 1.053 | 0.911 | 0.890 | 0.903 |

| | | | | | | | | | | | | |
|---|---|---|---|---|---|---|---|---|---|---|---|---|
| Evaluation results | Backspin rate (rpm) | 6,443 | 6,401 | 6,359 | 6,317 | 6,413 | 6,357 | 6,302 | 6.247 | 6,413 | 6,410 | 6,402 |
| | Initial velocity on approach shots (m/s) | 19.32 | 19.31 | 19.29 | 19.27 | 19.32 | 19.30 | 19.30 | 19.29 | 19.32 | 19.31 | 19.29 |
| | Controllability on approach shots | good | good | good | Exc | good | good | good | Exc | good | Exc | Exc |
| | Scuff resistance | good | good | good | good | good | good | good | good | good | good | good |
| | Moldability | good | good | good | good | good | good | good | good | good | good | Exc |

TABLE 3

| | | | Example | | | | | Comparative Example | | | | | |
|---|---|---|---|---|---|---|---|---|---|---|---|---|---|
| | | | 12 | 13 | 14 | 15 | 16 | 1 | 2 | 3 | 4 | 5 | 6 |
| Cover resin composition (pbw) | Component | TPU1 | 100 | 100 | 100 | 100 | 100 | 100 | 100 | 100 | 100 | 100 | 100 |
| | (I) | | | | | | | | | | | | |
| | Component | (Meth)acrylic | | | | | | 25 | | | | | |
| | (II) | block copolymer (1) | | | | | | | | | | | |
| | | (Meth)acrylic | | | | | | | | | | | |
| | | block copolymer (2) | | | | | | | | | | | |
| | | (Meth)acrylic | 15 | | | | | | | | | | |
| | | block copolymer (3) | | | | | | | | | | | |
| | | (Meth)acrylic | | 3 | 5 | 5 | 15 | | | | | | |
| | | block copolymer (4) | | | | | | | | | | | |
| | Component | PMMA1 | | | | | | | | 10 | | | |
| | (II′) | PMMA2 | | | | | | | | | 10 | | |
| | | Hydrogenated styrene | | | | | | | | | | 10 | |
| | | elastomer (1) | | | | | | | | | | | |
| | | Hydrogenated styrene | | | | | | | | | | | 10 |
| | | elastomer (2) | | | | | | | | | | | |
| | Component | Thermoplastic polyester | | | | 14.5 | | | | | | | |
| | (III) | elastomer | | | | | | | | | | | |
| Properties of resin composition | Component | Elastic work | 72.0 | 72.0 | 72.0 | 72.0 | 72.0 | 72.0 | 72.0 | 72.0 | 72.0 | 72.0 | 72.0 |
| | (I) | recovery: ηIta | | | | | | | | | | | |
| | | Martens hardness: HMa | 14.3 | 14.3 | 14.3 | 14.3 | 14.3 | 14.3 | 14.3 | 14.3 | 14.3 | 14.3 | 14.3 |
| | | Shore D hardness | 43.0 | 43.0 | 43.0 | 43.0 | 43.0 | 43.0 | 43.0 | 43.0 | 43.0 | 43.0 | 43.0 |
| | Component | Shore D hardness | 7 | 6 | 6 | 6 | 6 | 22 | — | 40 | 87 | 45 | 47 |
| | (II) | Rebound resilience (%) | 30 | 42 | 42 | 42 | 42 | 28 | — | 23 | 31 | 40 | 28 |
| | | Weight-average | 60,000 | 90,000 | 90,000 | 90,000 | 90,000 | 50,000 | — | | | | |
| | | molecular weight | | | | | | | | | | | |
| | Component | Shore D hardness | | | | 40 | | | | | | | |
| | (III) | Rebound resilience (%) | | | | 67 | | | | | | | |
| | | Melt viscosity (10⁴ × dPa · s) | | | | 0.57 | | | | | | | |
| | Cover | Elastic work | 69.9 | 71.9 | 71.2 | 72.1 | 67.6 | 66.7 | 72.0 | 68.7 | 67.3 | 67.7 | 66.1 |
| | | recovery: ηItb | | | | | | | | | | | |
| | | Martens hardness: HMb | 11.1 | 12.7 | 12.3 | 12.6 | 10.5 | 10.5 | 14.3 | 14.1 | 19.8 | 14.8 | 15.1 |
| | | Shore D hardness | 38.3 | 41.9 | 41.2 | 41.1 | 38.1 | 38.8 | 43.0 | 42.7 | 47.0 | 43.2 | 43.4 |
| Formulas | Formula (1) | HMa/HMb | 1.292 | 1.125 | 1.164 | 1.133 | 1.361 | 1.366 | — | 1.015 | 0.724 | 0.967 | 0.945 |
| | Formula (2) | ηItb/HMb | 7.105 | 5.913 | 6.016 | 5.912 | 6.527 | 6.369 | — | 5.215 | 3.589 | 4.974 | 4.678 |
| | Formula (3) | ηIta/ηItb | 1.031 | 1.001 | 1.012 | 0.999 | 1.065 | 1.080 | — | 1.048 | 1.070 | 1.064 | 1.089 |
| | Formula (4) | (ηIta · HMb)/(ηItb · HMa) | 0.798 | 0.890 | 0.869 | 0.882 | 0.783 | 0.791 | — | 1.033 | 1.478 | 1.100 | 1.153 |

| | | | | | | | | | | | | |
|---|---|---|---|---|---|---|---|---|---|---|---|---|
| Evaluation results | Backspin rate (rpm) | 6,395 | 6,415 | 6,413 | 6,405 | 6,405 | 6,234 | 6,417 | 6,247 | 6,113 | 6,275 | 6,204 |
| | Initial velocity on approach shots (m/s) | 19.27 | 19.31 | 19.30 | 19.28 | 19.27 | 19.24 | 19.33 | 19.24 | 19.21 | 19.32 | 19.26 |
| | Controllability on approach shots | Exc | good | Exc | Exc | Exc | Exc | NG | good | fair | fair | fair |
| | Scuff resistance | good | good | good | good | good | NG | good | good | good | good | good |
| | Moldability | Exc | good | good | Exc | Exc | NG | good | NG | NG | good | good |

As demonstrated by the results in Tables 2 and 3, the golf balls of Comparative Examples 1 to 6 are inferior in the following respects to the golf balls according to the present invention that are obtained in Examples 1 to 16.

In Comparative Example 1, the component (II) content of the resin composition is high. As a result, the controllability on approach shots is excellent, but the scuff resistance and moldability are inferior.

In Comparative Example 2, component (II) is not included in the resin composition. As a result, the controllability on approach shots is inferior.

In Comparative Example 3, component (II) is not included in the resin composition; instead, PMMA is included. Because the melt viscosity rises and the flowability worsens, it is necessary to raise the molding temperature. As a result, defects such as scorching arise over the entire surface of the cover and the moldability is inferior.

In Comparative Example 4, because PMMA is included in the resin composition, the melt viscosity rises and the flowability worsens, making it necessary to raise the molding temperature. As a result, defects such as scorching arise over the entire surface of the cover and the moldability is inferior. Also, because PMMA has a high hardness, the spin rate on approach shots decreases and so the controllability on approach shots worsens.

In Comparative Example 5, the value of HMa/HMb in Formula (1) is lower than the lower limit value of 1.020. As a result, the controllability on approach shots worsens.

In Comparative Example 6, the value of HMa/HMb in Formula (1) is lower than the lower limit value of 1.020. As a result, the controllability on approach shots worsens.

Japanese Patent Application Nos. 2021-163388 and 2021-204014 are incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a rubber core of at least one layer and a cover of at least one layer encasing the core, wherein at least one layer of the cover is formed of a resin composition comprising:
(I) a polyurethane or a polyurea, and
(II) a (meth)acrylic block copolymer;
the (meth)acrylic block copolymer serving as component (II) being included in an amount of not more than 20 parts by weight per 100 parts by weight of component (I).

2. The golf ball of claim 1, wherein the block copolymer serving as component (II) includes two or more blocks constituting hard segments and one or more block constituting a soft segment.

3. The golf ball of claim 1, wherein component (II) has a material hardness on the Shore D hardness scale of not more than 40.

4. The golf ball of claim 1, wherein component (II) has a rebound resilience, as measured according to JIS-K 6255, of not more than 50%.

5. The golf ball of claim 1, wherein the hard segments in the block copolymer serving as component (II) are composed primarily of methyl methacrylate units.

6. The golf ball of claim 1, wherein the soft segment in the block copolymer serving as component (II) is composed primarily of n-butyl acrylate units.

7. The golf ball of claim 1, wherein component (II) has a weight-average molecular weight of 10.000 or more.

8. The golf ball of claim 1, wherein the resin composition further comprises (III) a thermoplastic polyester elastomer.

9. The golf ball of claim 8, wherein component (III) has a material hardness on the Shore D hardness scale of from 20 to 50.

10. The golf ball of claim 8, wherein component (III) has a rebound resilience, as measured according to JIS-K 6255, of from 50 to 80%.

11. The golf ball of claim 8, wherein component (III) has a melt viscosity at 200° C. and a shear rate of 243 s⁻¹ of from 0.3×10⁴ to 1.5×10⁴ dPa·s.

12. The golf ball of claim 1, wherein the cover has a Shore D hardness of not more than 48.

13. The golf ball of claim 1 wherein, letting HMa (N/mm²) be the Martens hardness of the resin material serving as component (I) and HMb (N/mm²) be the Martens hardness of the cover layer formed of the resin composition containing components (I) and (II), HMa its and HMb satisfy formula (1) below
1.020≤HMa/HMb≤1.500 (1)

14. The golf ball of claim 13 wherein, letting ηItb (%) be the elastic work recovery of the cover layer formed of the resin composition containing components (I) and (II), ηItb and HMb satisfy formula (2) below
5.00≤ηItb/HMb≤8.00 (2).

15. The golf ball of claim 14 wherein, letting ηIta (%) be the elastic work recovery of the resin material of component (I), ηIta and ηItb satisfy formula (3) below
0.97≤ηIta/ηItb≤1.12 (3).

16. The golf ball of claim 15 which further satisfies formula (4) below
0.70≤(ηIta·HMb)/(ηItb·HMa)≤1.06 (4).
